(19) United States
(12) Patent Application Publication
(10) Pub. No.: US 2013/0013648 A1
(43) Pub. Date: Jan. 10, 2013

(54) METHOD FOR DATABASE STORAGE OF A TABLE WITH PLURAL SCHEMAS

(75) Inventors: Miguel Angel Monjas Llorente, Madrid (ES); Gabriel Huecas, Madrid (ES); Alberto Mozo, Madrid (ES); Juan Quemada, Madrid (ES); Joaquin Salvachua, Madrid (ES)

(73) Assignee: Telefonaktiebolaget L. M Ericsson (PUBL), Stockholm (SE)

(21) Appl. No.: 13/635,541

(22) PCT Filed: Mar. 17, 2010
(86) PCT No.: PCT/EP2010/053489

§ 371 Date: Sep. 17, 2012

(51) Int. Cl. G06F 7/00; G06F 17/30

(52) U.S. Cl. 707/803; 707/812; 707/E17.005; 707/E17.044

(57) ABSTRACT

A method of storing data in a database, the database defining a table and the data comprising at least one record. Each record comprises values for at least one field. The method comprises storing a plurality of schemas, each schema defining a respective set of fields associated with said table, wherein each of said records is associated with identification data identifying one of said schemas.

### TECHNICAL FIELD

The present invention relates to methods of storing data in a database and more particularly to methods of storing data in a database where a table in the database is associated with a plurality of schemas defining respective sets of fields associated with the table.

### BACKGROUND

Many modern applications require storage of large amounts of data. Generally, data is stored in one or more structured collections of data collectively referred to as a database. In order to manage the large quantities of data stored in modern databases, it is common to use a Database Management System to facilitate the creation and maintenance of a database.

A common type of database is a relational database. A relational database represents data as a collection of relations. Each relation comprises a plurality of tuples, each tuple providing values for common attributes. Relations are logically represented by table organized into rows and columns. Each row of a table represents a tuple of a relation and each column represents an attribute of that relation.

Tuples are stored in a computer system as “records”. Each tuple attribute value is represented by a sequence of bytes within a record, referred to as a field.

Relational Database Management Systems (RDBMS) execute query operations provided by a user application. Query operations are executed on database records stored in a main memory of the computer. Due to the need for rapid access to data, main memory is generally provided by Random Access Memory (RAM). While providing the requisite fast access times, the types of RAM commonly used to provide main memory are volatile storage technologies, requiring power to store information. Further, the relatively high cost of RAM means that, for reasonably large databases, the main memory is insufficiently large to store all records of all tables of a database.

As such, database tables are also stored in a secondary memory, generally provided by slower but higher capacity, non volatile, storage devices such as hard disk drives.

Where it is desired to read or modify a record of a database, it is first determined whether that record is present in main memory. If a particular record is not present in main memory, it is located in secondary memory and copied to main memory for processing. Where main memory has insufficient free space to store an additional record copied from secondary memory, it is necessary to determine which of the records stored in main memory should be ejected to create space to store the additional record copied from the secondary memory. If the record chosen for ejection from main memory has been modified whilst in main memory, the modified record is copied back to secondary memory in order to ensure that changes are not lost when the record is ejected from main memory.

Data is stored in memory in collections of eight bits, each of which is called a byte. Disks are logically arranged into fixed size groups of a particular number of bytes, generally known as “blocks”. Operations to read data from and write data to a disk are collectively known as I/O operations, and it is generally more efficient to read and write a whole number of blocks in each I/O operation.

Records included in tables of a database are stored in groups called pages. Often, the size of the pages of a database is selected to match the block size of a hard disk on which the database is stored. In this way, when records of a database are copied between the hard disk and the main memory in whole pages, rather than individual records, efficiency of record transfer between the main and secondary memory can be maximised. That is, when a particular record is required, the page containing that record is copied from the secondary memory to the main memory. If the record is modified, the whole page (including the modification) is copied from the main memory to the secondary memory.

A common approach to database management defines a fixed structure for records associated with a particular table by defining a schema for each table before any data is added to the database. Such a schema defines a number of fields for which each record provides values and further defines a data type for each field and other like information.

However, a problem arises when a change is required in the structure of the database. For example, user applications may wish to add a new field to records associated with a particular table, alter the format of an existing field or delete one or more existing fields. Although such changes can often be applied to a database which already contains data, when this is done it is necessary to reorganise all of the data in the database in accordance with the new structure. Given that errors are likely to occur if a user application is allowed to access the data during such a reorganisation, it is commonly necessary to prevent access to the database during reorganisation. This results in an interruption of service of the services provided by the applications that use the database for their operation, which is undesirable, especially for those applications having strict availability requirements (e.g. 24 hours a day, seven days a week).

It is an object of the present invention to obviate or mitigate at least some of the problems outlined above.

### SUMMARY

According to a first aspect of the present invention, there is provided a method of storing data in a database, the database defining a table and the data comprising a plurality of records, each record comprising values for at least one field. The method comprises storing a plurality of schemas, each schema defining a respective set of fields associated with said table, and associating each of said records with identification data identifying one of said schemas.

Storing a plurality of schemas defining respective sets of fields associated with a particular table is advantageous in that different records associated with the particular table need not share the same schema. It may be the case that initially, records of the particular table are defined using a first schema, but it is later desired to define a second schema which is to be used to define further records of the particular table. By using the method described above, records defined before the second schema is created can continue to be defined according to the first schema. This provides for the addition of new records, being associated with a new schema, to a table without the need to update data already stored in the table. Thus, the task of updating of the structure of a table is rendered independent of the task of updating the structure of data already associated with said table, which negates the need to perform large scale batch updates of data in a database upon changing the structure of a database table. This provides a number of advantages including a shortening of the time taken to perform an update process.

That is, in some conventional arrangements, where an ALTER TABLE command is used, the structure of all records of particular table is updated. This is computationally expensive and commonly requires at least write operations (e.g. insert and update operations) by user applications to be prevented while the command executes; which can be unacceptable for some applications. By simply adding a new schema definition and allowing records to be defined according to both the old and new schema, considerable benefits are realised. Thus, it is possible to define a new field in a particular table by defining a new schema. Newly created records, and updated records, may include the new field if they have associated identification data referencing the new schema. Other records, however, need not include the new field, as they may continue to be associated with identification data referencing an earlier schema.

Each of said schemas may have an associated schema identifier, and the identification data may comprise a schema identifier. For example, each schema may have an associated version number, thereby allowing easy differentiation between different schemas for a particular table.

The plurality of schemas may be stored in a data dictionary of said database. The data dictionary is sometimes referred to as a system catalog and the terms data dictionary and system catalog are used analogously herein. A data dictionary typically contains information about the tables of the database, and may include data indicating table names, index names and integrity constraints on the data in addition to schemas for the database tables.

The method may further comprise creating a further schema defining a further set of fields of data associated with said table and storing said further schema.

The method may further comprise reading one of said records and modifying identification data associated with said read record to identify another of said plurality of schemas.

A plurality of records may have common associated identification data. That is, a single item of identification data may be associated with a plurality of records indicating that each of said plurality of records is associated with a schema identified by said identification data. For example, said plurality records may be stored in one or more pages. Associating each of said records with identification data identifying one of said schemas may comprise associating identification data with each page and storing in each page only records associated with one of said schemas identified by the identification data associated with that page. That is, a single item of identification data may be stored for each page and be associated with all records stored in that page.

The method may further comprise reading a first record from a first page of records, said first page of records being associated with identification data identifying a first schema, receiving update data to be used to update said first record, and storing a second record in a second page of records, said second record being based upon said first record and said update data and said second page being associated with identification data identifying a second schema.

Each record may be associated respective identification data identifying one of said plurality of schemas. Identification data may be stored in each record, for example in a header of each record.

The method may further comprise reading a record, said record being associated with identification data identifying a first schema, receiving update data to be used to update said record, and updating the said record based upon said update data and modifying identification data associated with said record to identify a second schema.

A first schema of said plurality of schemas may comprise a first plurality of fields and a second schema of said plurality of schemas may comprise a second plurality of fields, said second plurality of fields including said first plurality of fields and at least one further field. Said at least one further field of said second schema may be associated with at least one default value. Alternatively, the second plurality of fields may be a subset of said first plurality of fields.

According to a second aspect of the present invention, there is provided a method of reading a record from a database, the database defining a table and the data comprising a plurality of records, each record comprising a value for at least one field, the database storing a plurality of schemas, and each schema defining a respective set of fields associated with said table. The method comprises reading identification data associated with said record to identify one of said schemas, and reading said at least one record based upon said identified schema. Reading a record from the database can be related to an operation from a user of said database for merely obtaining data contents of a record and/or for updating contents of said record.

Features described in the context of the first aspect of the invention can be applied to the second aspect of the invention.

Embodiments of the invention can be implemented in any convenient way, including by way of suitable computer programs. As such, aspects of the invention also provide a computer readable medium carrying computer readable instructions configured to carry out a method as described above when loaded into a computer apparatus.

There is also provided computer apparatus comprising a memory storing processor readable instructions, and a processor configured to read and execute instruction stored in said memory. Said processor readable instructions comprise instructions controlling the processor to carry out a method as described above.

### BRIEF DESCRIPTION OF THE DRAWINGS

Embodiments of the invention are now described, by way of example only, with reference to the accompanying drawings, in which:

FIG. 1 is a schematic illustration of a computer system configured to provide a database in accordance with an embodiment of the invention;

FIG. 2 is a schematic illustration of structures used to implement a conventional database;

FIG. 3 is a schematic illustration showing how the structures of FIG. 2 are modified to implement an embodiment of the invention;

FIG. 4 is a flow chart showing processing carried out to add a schema for a table to a database implemented using the structures of FIG. 3;

FIG. 5 is a flow chart showing processing carried out to read a record from a database implemented using the structures of FIG. 3;

FIG. 6 is a flow chart showing processing carried out to store a record in a database implemented using the structures of FIG. 3;

FIG. 7 is a schematic illustration of two pages showing an update operation;

FIG. 8 is a flow chart showing processing carried out to update a stored record;

FIG. 9 is a schematic illustration of two schemas for a table named “Fruit”;

FIG. 10 is a schematic illustration of three records of the “Fruit” table; and

FIGS. 11 and 12 are schematic illustrations of the “Fruit” table;

### DETAILED DESCRIPTION

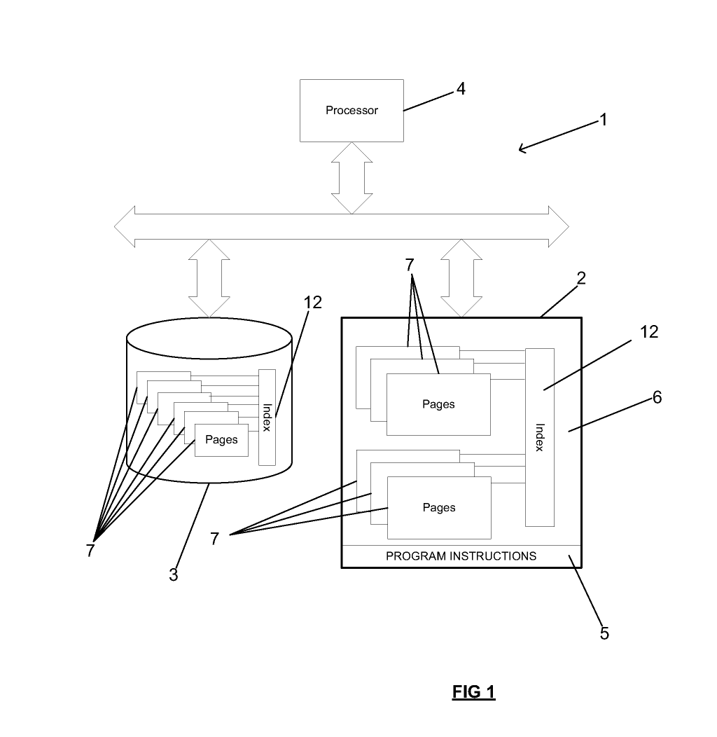

FIG. 1 shows a computer 1 arranged to implement an embodiment of the invention. The computer 1 comprises a main memory 2 provided by RAM and a secondary memory 3 provided by a hard disk drive. A processor 4 is arranged to read and execute instructions stored in a first logical part 5 of the main memory 2. Data manipulated by those instructions is stored in a second logical part 6 of the main memory 2. The instructions stored in the first logical part 5 of the main memory 2, amongst other things, control the processor 4 to copy data between the second logical part 6 of the main memory 2 and the secondary memory 3.

The instructions stored in the first logical part 5 of the main memory 2 control the processing of data stored in the main memory 2 which forms part of a relational database stored in the secondary memory 3. Data of the relational database is stored in both the main memory 2 and the secondary memory 3 in the form of a plurality of pages 7, each page comprising a predetermined quantity of data in the form of database records. Data is transferred between the secondary memory 3 and the main memory 2 in whole pages. The main memory 2 is not large enough to hold all pages 7 at the same time. Secondary memory 3 is therefore used to store all of the pages 7, and the instructions control the processor 4 to copy pages 7 from secondary memory 3 to main memory 2 when required for processing, and back to secondary memory 3 for persistent storage when no longer required in the main memory 2.

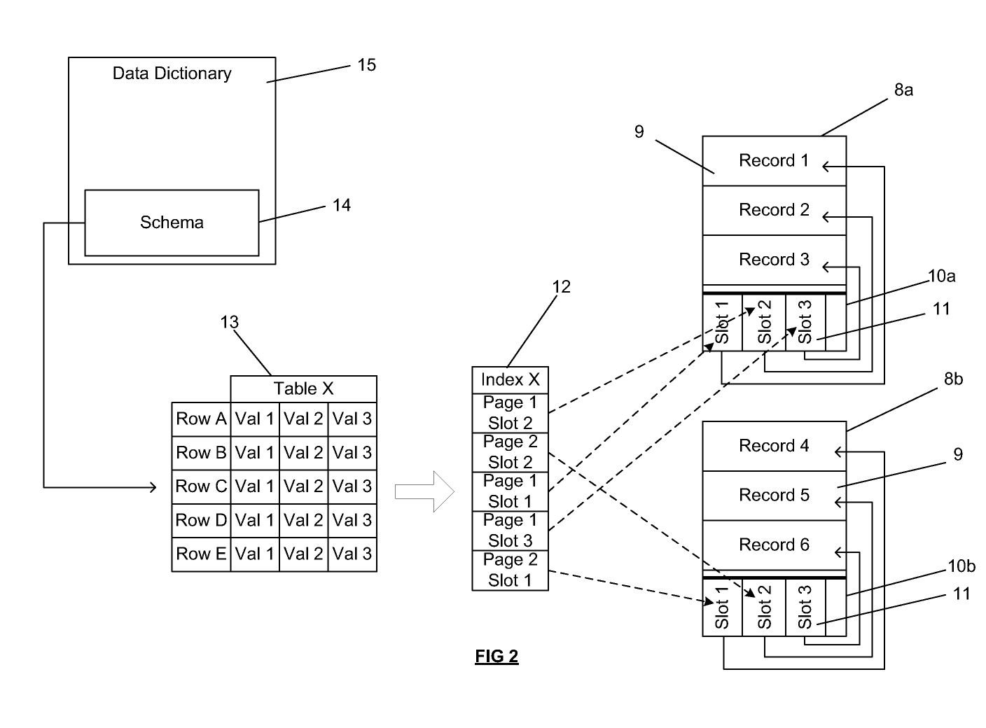

FIG. 2 shows two pages 8a and 8b comprising records 9. Each of the pages 8a, 8b comprises a header 10a, 10b comprising a number of fields referred to as “slots” 11. Each slot stores an offset within the page where a particular record 9 is stored. The use of slots 11 in this way allows records of variable length to be used, given that each slot 11 can store an offset determined by the size of the particular records within the page which precede a record referenced by a particular slot. In this way, different records may have different sizes, and in particular data associated with a particular field may occupy a different amount of space in different records. Using storage of the type described, each record can be conveniently identified using a record identifier (rid) comprising a page identifier and a slot identifier. For example Record 2 shown in FIG. 2 has an rid identifying the page 8a and Slot 2.

In order to allow user applications executed by the processor 4 to efficiently locate particular records of a particular database table, an additional data structure called an index 12 is used. The index 12 is an ordered list of record references using some record field as an ordering criterion. Each database table has at least one index to allow traversal across all records of the database table. The ordering criterion of the index is established using a non-null value attribute, referred to as a ‘key’, of the table. Each time a record is inserted into or deleted from a table, the associated table index is updated. A record identifier (rid) is saved in each index cell to allow access to a respective record when traversing an index.

The stored records 9 comprise values for each of a plurality of fields defined by a table with which the records are associated. For example, in the example of FIG. 2, the records 9 are associated with a table 13. A schema 14 is associated with the table 13 and is stored in a data dictionary 15 (the data dictionary 15 is also sometimes referred to as a system catalog). The schema 14 indicates that each record associated with the table 13 stores data values for three fields, and the schematic illustration of the table 13 shows that each record comprises three data values, one for each of the three fields. More generally, the data dictionary 15 contains information about the tables of the database, and includes data indicating table names, index names and integrity constraints on the data in addition to schemas for the database tables of the type described above. The data dictionary may also comprise further information such as definitions of the relations between tables of the database and user access permissions for the database.

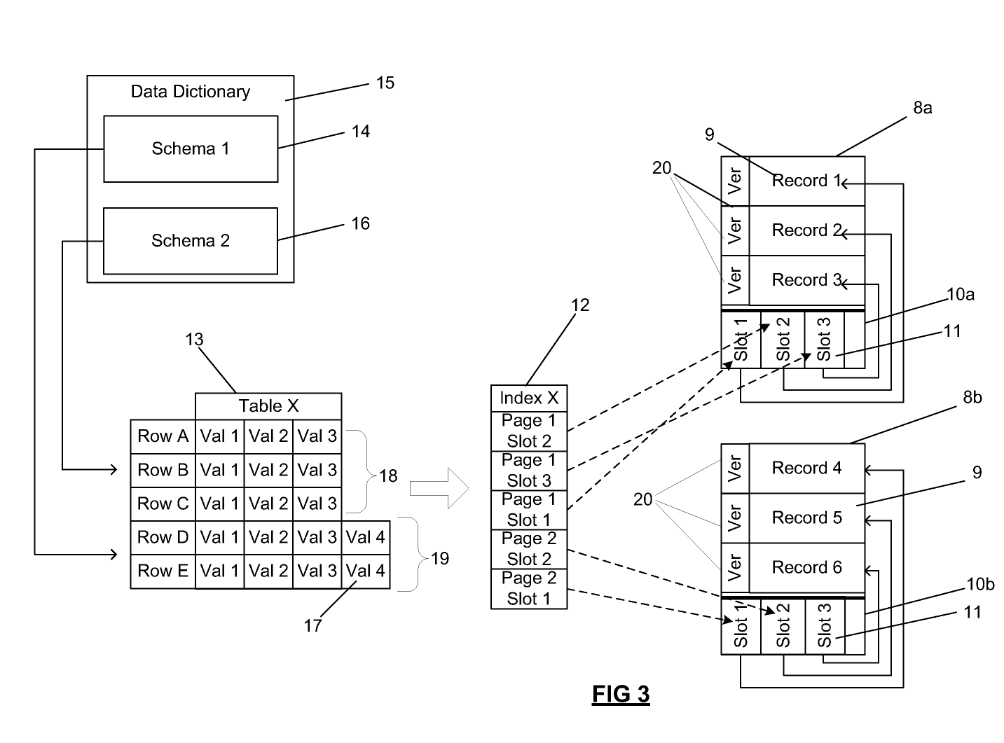

FIG. 3 shows a modification of the arrangement of FIG. 2 in accordance with an embodiment of the invention. It can be seen that the data dictionary 15 now comprises a further schema 16. Both of the first schema 14 and the second schema 16 are associated with the table 13, but specify respective properties for the table 13. More particularly, the second schema 16 includes the definition of an additional field 17 for the table 13. As such records of a first set of records 18 associated with the table 13 each comprise values for three fields specified by the first schema 14, while records of a second set of records 19 associated with the table 13 each comprise values for four fields as specified by the second schema 16. It will be appreciated that in other examples the second schema 16 may only comprise a subset of the fields of the first schema 14, thereby allowing removal of obsolete fields.

Each of the schemas 14, 16 has an associated version number, allowing convenient identification of each schema. Where two schemas 14, 16 are provided in this way, each record 9 is provided with a version number field 20 so as to identify a schema according to which the record is defined. In this way, a plurality of different schemas 14, 16 can be provided for a single table, and records can be defined and stored according to each of the schemas. This is particularly convenient as further schemas can be added to the data dictionary 15 and records then added which use one of the further schemas, the records simply comprising data which identifies the appropriate schema.

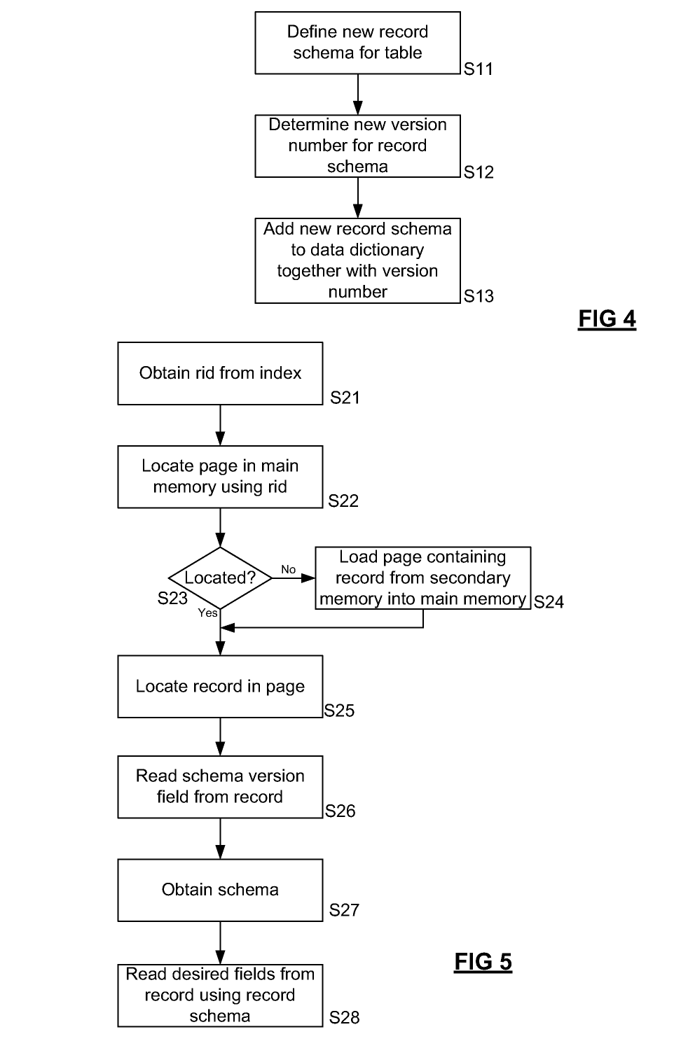

Processing carried out using the structures described with reference to FIG. 3 is now described with reference to FIGS. 4 to 8.

FIG. 4 is a flowchart showing processing carried out to add a schema to the data dictionary 15. The method is performed by the processor 4 executing instructions stored in the first portion 5 of the main memory 2. At step S11, a new schema is defined for the table 13. The new schema, may for example, define an additional field for the table 13 and may specify a default value for that additional field. At step S12 the highest current version number for schemas associated with the table 13 is determined, and a next version number is selected for the new record schema. At step S13 the new schema is added to the data dictionary 15 with the appropriate version number. When the new schema has been added to the data dictionary 15 in this way, records can be stored which are associated with the table 13, with a version number identifying the new schema.

FIG. 5 shows processing carried out to read data from the table 13. The processing is performed by the processor 4 executing instructions stored in the first portion 5 of the main memory 2. At step S21 a record identifier of a desired record is obtained from the index 12. As discussed above, the record identifier comprises a page number and slot number within a page. At step S22 an attempt is made to locate a page indicated by the rid in the main memory 2. At step S23 a check is made to determine whether the page indicated by the rid has been successfully located in the main memory 2. If this is not the case, the identified page is loaded into the main memory 2 from the secondary memory 3 at step S24 and processing passes to step S25. If the page is located in the main memory 2 at step S22, processing passes directly from step S23 to step S25.

At step S25 the record is located within the relevant page using the slot number included within the rid. At step S26 the version field 20 of the record is read so as to determine a schema with which the read record is associated. At step S27, a schema associated with the read version number is obtained from the data dictionary 15. At step S28, each of the fields of the record is read in turn, using the read schema obtained at step S27. In particular, the schema allows identification of the fields included in the record, including identification of the location of the start and end of each field, so as to enable values for each field to be read.

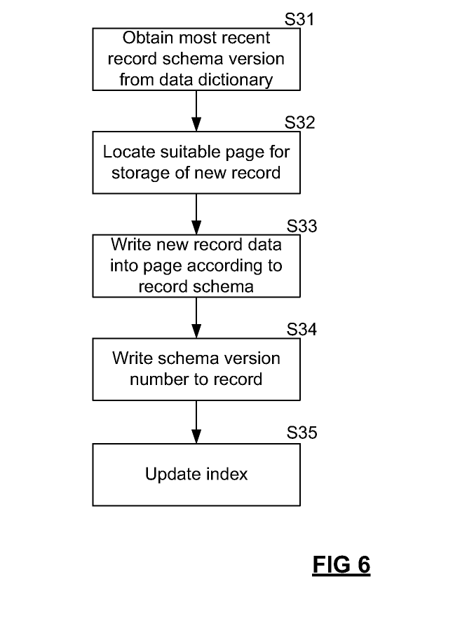

The flowchart of FIG. 6 shows processing carried out to add a record to a database. The processing is performed by the processor 4 executing instructions stored in the first portion 5 of the main memory 2. At step S31 a most recent version of the schema for a table with which the record is associated is obtained from the data dictionary 15.

In this way, when a new record is added to the database, that new record is associated with the most recently added schema for the relevant database table. At step S32 a page suitable for storage of the new record is identified. The identification of a page for storage of the record will depend upon the way in which records are allocated to pages. For example, if each page stores records associated with a particular schema for a particular database table, a page storing records defined according to the relevant schema is located. The location of an appropriate page may involve copying a page from the secondary memory 2 into the main memory 3, or may involve the creation of an entirely new page. However where a page can store records associated with different schemas, a most recently created page can be used to store the record if enough space is available in the most recently created page, otherwise a new page may be created. At step S33 the new record is added to the located page, and at step S34 the schema version number associated with the schema obtained at step S31 is written to the new record. At step S35 the index 12 is updated so as to indicate the existence of the new record and so as to indicate a page and slot number where the record is stored.

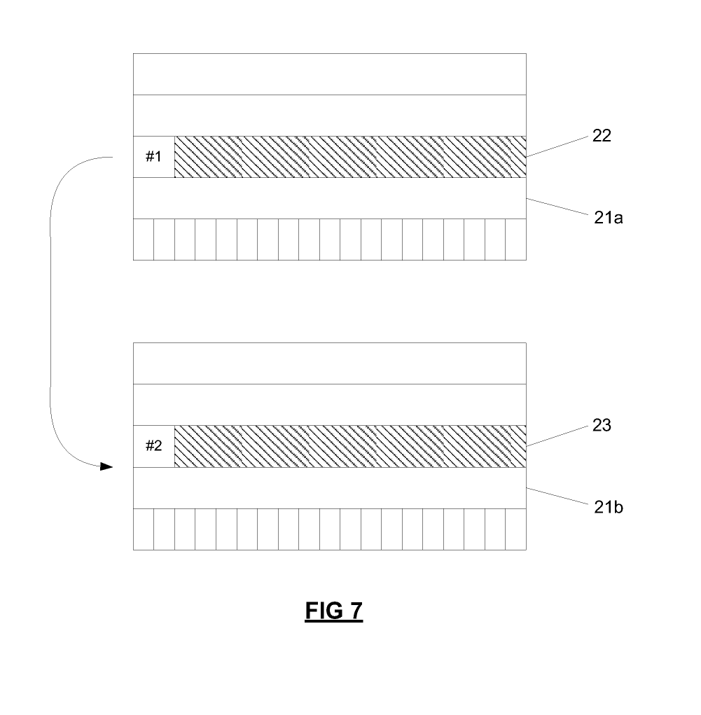

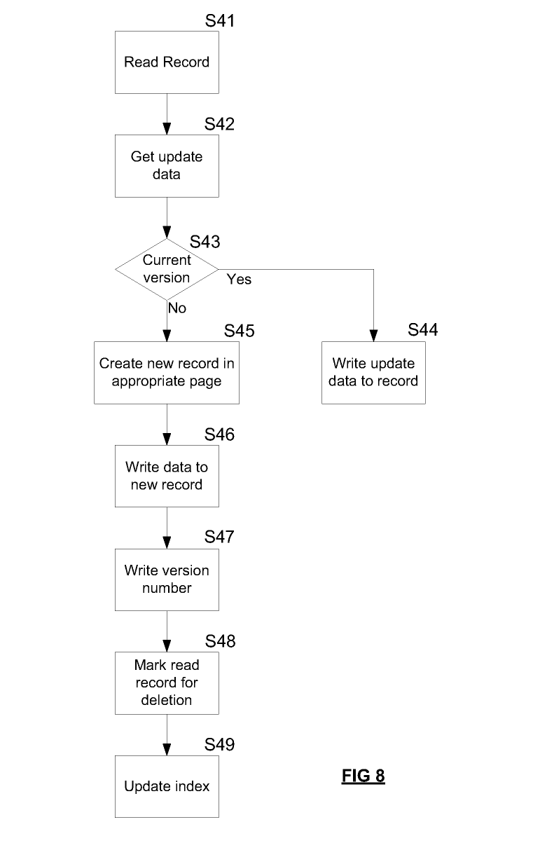

Processing carried out to update a record is now described with reference to FIGS. 7 and 8.

FIG. 7 shows two pages 21a, 21b storing database records. A record 22 is to be updated. Referring to FIG. 8, at step S41 the record 22 is read, and at step S42 update data which is to be used to update the record 22 is obtained. At step S43 a check is carried out to determine whether the version number associated with the record read at step S41 references the most up to date schema for the relevant database table. If this is the case, the update data is used to update the record 22 within the page 21a at step S44.

If however the check of step S43 determines that the version number associated with the record read at step S41 is not the most up to date version number, a new record is created at step S45. In the described example, a new record 23 is created in the page 21b, as the page 21b is used to store records associated with the most up to date schema for the relevant table. At step S46 data is written to the new record, based upon data read at step S41, the update data obtained at step S42 and the most up to date schema for the relevant table. At step S47 the version number identifying the most up to date schema is written to the record 23. At step S48 the record 22 is marked as obsolete, such that a process can be run to recover space used to store the record 22 when appropriate. The record 22 may be marked obsolete by writing a “tomb-stone” value to an appropriate field of the record.

Processing passes from step S48 to step S49 where the index 12 is updated to indicate the location at which the record is stored.

In an alternative embodiment of the invention, even if it is determined at step S43 that the record read at step S41 is not associated with the most up to date version of the schema, if the update data obtained at step S42 does not require that the schema used to define the record is updated (for example the update data does not refer to a field which is not defined by the version of the schema currently defining the record), and if the page 21a has sufficient space to accommodate the required update, the record 22 is updated within the page 21a, instead of the record 23 being created. This may be advantageous in some circumstances given that the need to create a new record in a new page is avoided.

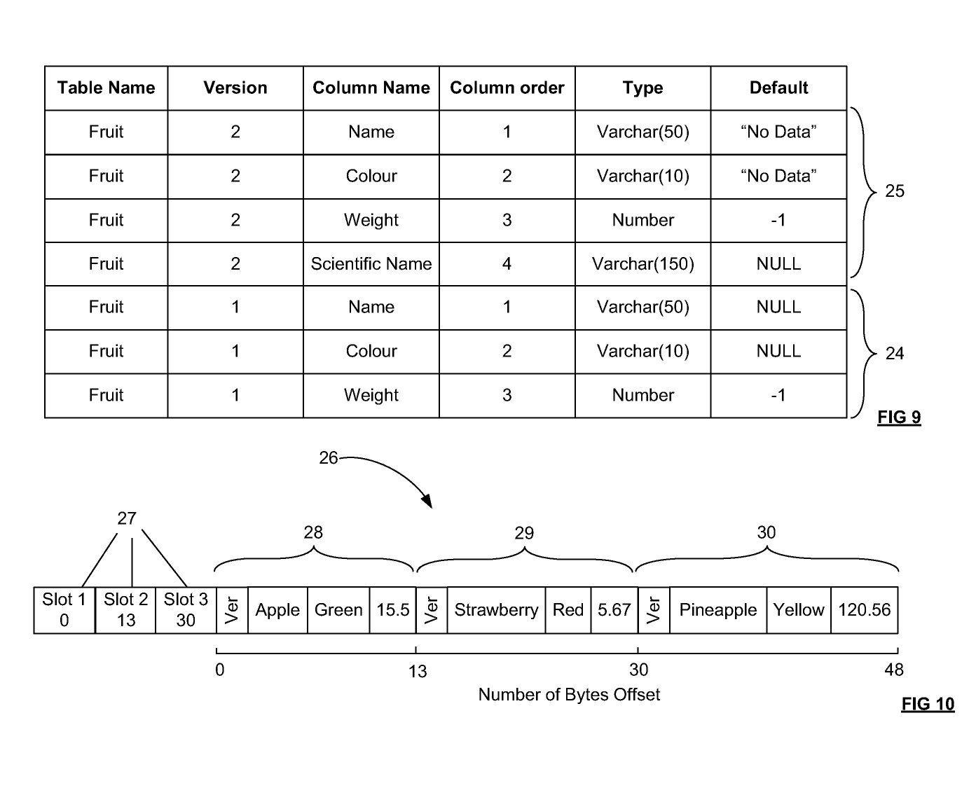

A specific example of a database implemented using the structures and methods described above is now presented with reference to FIGS. 9 to 12.

FIG. 9 shows first and second schemas 24, 25 associated with a table named “Fruit” in a database. The first schema 24 defines three fields named Name, Colour and Weight, defines column positions for each of these fields, defines a data type for each field and a default value for each field.

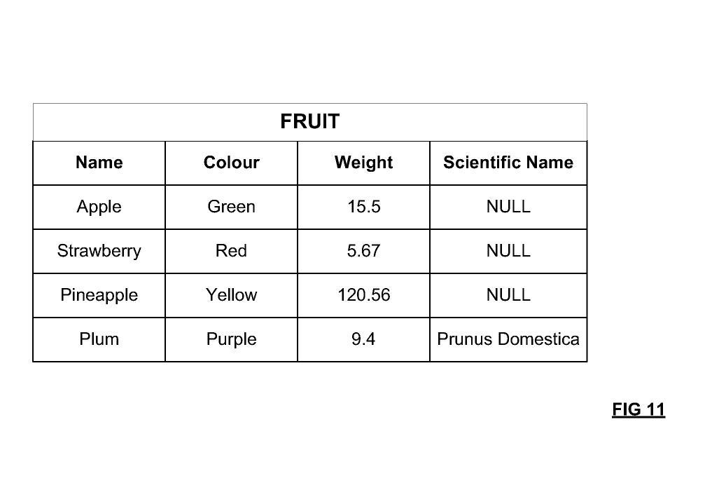

FIG. 10 shows part of a page 26 storing three records defined according to the first schema 24. The page 26 includes three slots 27 referencing three records by their offsets within the page 26. A first slot references a first record 28 which begins at an offset of zero and comprises data associated with a record in which the name field has a value “Apple”. A second slot references a second record 29 which begins at an offset of thirteen and comprises data associated with a record in which the name field has a value “Strawberry”. A third slot references a third record 30 which begins at an offset of thirty and comprises data associated with a record in which the name field has a value “Pineapple”.

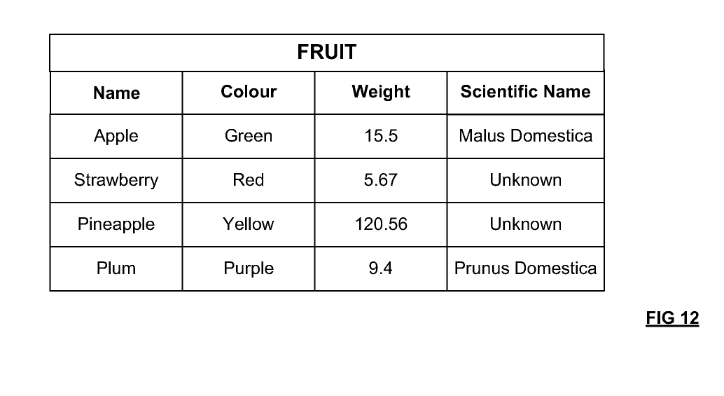

Subsequent to the creation of the first schema 24 and storage of the three records 28, 29, 30, the second schema 25 is created using processing described with reference to FIG. 4. It can be seen that the second schema 25 defines the three fields discussed with reference to the first schema 24, but additionally defines a “Scientific Name” field. When the second schema 25 has been created in this way, newly created records are associated with the second schema 25, as described with reference to the processing of FIG. 5. Similarly, where a record associated with the first schema 24 is updated in any way, it may be updated to reference to the second schema 25 as described with reference to FIGS. 7 and 8. In this way, the “Fruit” table comprises some records associated with the second schema 25, and other records associated with the first schema 24, each record identifying one of the schemas 24, 25. FIG. 11 shows records of the “Fruit” table. It can be seen that three records 31 described with reference to FIG. 10 comprise values for the three fields defined by the first schema 24, while a new record 32 having a Name field value of “Plum” comprises values for the four fields defined by the second schema 25. However, it can be seen from FIG. 12 that following an update operation, the record having the Name field value of “Apple” is defined using the second schema 25 and now comprises a value for the additional field “Scientific Name”.

The preceding description has been concerned with an embodiment in which each record has an associated version number field which is used to identify a stored schema. In alternative embodiments a page may comprise a version number field, and this field may be used to associate all records within the page with a particular schema version, thereby obviating the need for each record to include its own version number field. In such an embodiment it will be appreciated that all records in a particular page are associated with a common schema for a particular database table.

It will be appreciated that the data dictionary, and therefore the schemas discussed above, may be internally represented within the database in any convenient way and does not need to be in tabular form as shown in FIG. 9 or, indeed, held in a single structure. That is, each schema may, for example, be stored as a discrete structure within the data dictionary 15.

It has been described above that when a record becomes obsolete (e.g. when it is updated in such a way as to create a new record in a new page) the record is appropriately identified as being obsolete. When all records within a particular page are obsolete storage space used to accommodate the page can be released so as to allow that storage space to be used to store other data. A process may run in the background to identify pages which can be discarded in this way. Additionally, in some embodiments, processing may be carried out so as to move non-obsolete records from pages including obsolete records, so as to bring forward the time at which a page may be discarded.

If a clustered index is implemented, then records ordered by a clustered index key can be stored sequentially in a single page to allow access to several consecutive records by accessing only that single pages. The use of clustered indices is often important in a relational database because such indices provide a great performance benefits when sequentially accessing all the records contained in a database table.

During an update operation, and when a new record is created, instead of inserting the record in a new page (as was described above with reference to FIGS. 7 and 8), the new record can instead be reallocated into the same page if records include a schema identifier, variable length records can be accommodated within the page and the page has sufficient free space to accommodate the new record. If there is insufficient free space within the particular page, an overflow page can be used to avoid the new record being stored in an entirely different location from its neighboring records. Such an approach allows the efficiency benefits achieved through the use of clustered indices to be maintained in embodiments of the invention.

Handling update operations in this way is also advantageous in that the rid (record identifier) contained in the index does not need to be updated as part of the update operation, given the record remains located in the same slot of the same page.

Where clustered indices are used, a similar procedure to that described immediately above for processing updates can be used when inserting a new record, More particularly, the new record may be inserted in a page determined by a key of the clustered index. Where pages can store records of different lengths, records associated with different schemas can be stored within a single page, as explained above.

It has been explained that the methods described above allow records associated with a particular table to be defined according to a plurality of schemas. In some embodiments, records defined according to a schema other than the most recently defined schema may be processed so as to update them to be defined according to the most recently defined schema. Such processing may be carried out when database load is low. In this way all records are updated such that the database table converges to be defined according to the most recently defined schema, without jeopardizing database performance.

It will be appreciated that where different records associated with a particular table are defined according to different schemas, some records may not comprise data for particular fields which are defined in one schema, but not in another. There are various ways in which such missing data can be handled. For example, where a new schema adds a field to table, where a query returns a record defined using an earlier version of the schema not including that field, the value returned may be default value defined by the new schema. Alternatively, a value may be returned indicating that no data is stored for the particular field.

Various modifications and applications of the present invention will be readily apparent to the appropriately skilled person from the teaching herein, without departing form the scope of the appended claims.

1. A method of storing data in a database, the database defining a table of data relations and the data comprising a plurality of records, each record comprising a data value for at least one field according to data relations of said table, the method comprising:
storing a plurality of schemas, each schema defining a respective set of fields of data associated with said table; and
associating each of said records with identification data identifying one of said schemas.

2. A method according to claim 1, wherein each of said schemas has an associated schema identifier, and said identification data comprises a schema identifier,

3. A method according to claim 1, wherein said plurality of schemas are stored in a data dictionary of said database.

4. A method according to claim 1, further comprising:
creating a further schema defining a further set of fields of data associated with said table; and
storing said further schema.

5. A method according to claim 1, further comprising:
reading one of said records; and
modifying identification data associated with said read record to identify another of said plurality of schemas.

6. A method according to claim 1, wherein a plurality of records have common associated identification data.

7. A method according to claim 6, wherein said plurality records are stored in one or more pages, and wherein associating each of said records with identification data identifying one of said schemas comprises:
associating identification data with each page; and
storing in each page only records associated with one of said schemas identified by the identification data associated with that page.

8. A method according to claim 7, further comprising:
reading a first record from a first page of records, said first page of records being associated with identification data identifying a first schema;
receiving update data to be used to update said first record; and
storing a second record in a second page of records, said second record being based upon said first record and said update data and said second page being associated with identification data identifying a second schema.

9. A method according to claim 1, wherein associating each record with identification data identifying one of said schemas comprises storing in each record the respective identification data.

10. A method according to claim 9, further comprising:
reading a record, said record being associated with identification data identifying a first schema;
receiving update data to be used to update said record; and
updating said record based upon said update data and modifying identification data stored on said record to identify a second schema.

11. A method according to claim 1, wherein a first schema of said plurality of schemas comprises a first plurality of fields of data and a second schema of said plurality of schemas comprises a second plurality of fields of data, said second plurality of fields including said first plurality of fields and at least one further field of data.

12. A method according to claim 11, wherein said at least one further field of said second schema is associated with at least one default value.

13. A method of reading from a database, the database defining a table and the data comprising a plurality of records, each record comprising data value for at least one field, the database storing a plurality of schemas, each schema defining a respective set of fields associated with said table, the method comprising:
reading identification data associated with at least one record to identify one of said schemas; and
reading said at least one record based upon said identified schema.

14. A non-transitory computer readable medium storing computer readable instructions configured to store data in a database the database defining a table of data relations and the data comprising a plurality of records, each record comprising a data value for at least one field according to data relations of said table, the computer readable instructions comprising:
a set of instructions for star of schemas, each schema defining a respective set of fields of data associated with said table; and
a set of instructions for associating each of said records with identification data identifying one of said schemas.

15. Computer apparatus for storing data in a database, the database defining a table of data relations and the data comprising a plurality of records, each record comprising a data value for at least one field according to data relations of said table, the apparatus comprising:
a memory storing processor readable instructions; and
a processor configured to read and execute instructions stored in said memory;
wherein said processor readable instructions comprise:
a set of instructions for storing a plurality of schemas, each schema defining respective set of fields of data associated with said table; and
a set of instructions for associating each of said records with identification data identifying one of said schemas.
